(19) United States
(12) Patent Application Publication
(10) Pub. No.: US 2019/0244163 A1
(43) Pub. Date: Aug. 8, 2019

(54) Automated Inventory Intelligence Systems and Methods

(71) Applicant: Adroit Worldwide Media, Inc., Aliso Viejo, CA (US)

(72) Inventors: Kevin Howard, Aliso Viejo, CA (US); Kurtis Van Horn, Aliso Viejo, CA (US); Emad Mirgoli, Aliso Viejo, CA (US); Greg Schumacher, Aliso Viejo, CA (US); Eric Johnson, Aliso Viejo, CA (US)

(73) Assignee: Adroit Worldwide Media, Inc., Aliso Viejo, CA (US)

(21) Appl. No.: 16/269,315

(22) Filed: Feb. 6, 2019

Related U.S. Application Data
(60) Provisional application No. 62/627,085, filed on Feb. 6, 2018.

(51) Int. Cl. G06Q 10/08; G06N 5/02; G06Q 10/10

(52) U.S. Cl. CPC G06Q 10/087; G06Q 10/107; G06N 5/02

(57) ABSTRACT

An automated inventory intelligence system is disclosed including, in some embodiments, an artificial intelligence (“AI”) agent configured to monitor inventory states in designated areas of an environment. The AI agent includes sensors, effectors, and an agent program. The sensors are configured to be disposed in the environment to collect sensory information on inventory items in the designated areas. The effectors are configured for response to inventory state changes in the designated areas. The agent program is configured to receive sensor data from the sensors for current inventory states, as well as send instructions to the effectors for the response to the inventory state changes. In addition, the automated inventory intelligence system includes a system memory configured to store an instance of the agent program at runtime and one or more previous inventory states for determining the inventory state changes from the current inventory states.

### PRIORITY

This application claims the benefit of priority to U.S. Provisional Patent Application No. 62/627,085, filed Feb. 6, 2018, titled “Automated Inventory Intelligence Systems and Methods,” which is hereby incorporated by reference into this application in its entirety.

### FIELD

The field of the present disclosure generally relates to merchandising systems. More particularly, the field of the invention relates to an apparatus and a method for an intelligent shelf system capable of facilitating increased operational efficiencies for retailers.

### BACKGROUND

Retail environments are ever challenging. Consumers typically are confronted with pricing and information about a continuously increasing number of competitors and brands, including information about pricing, labeling, promotions, and the like. Traditionally, this information has been provided using print systems, such as slide-in paper systems, plastic label systems, and adhesive label systems. However, consumers are increasingly confounded by the sheer volume of printed information displayed in retail environments, and thus a growing number of consumers are turning to online shopping for day-to-day purchases. Furthermore, a retailer's overall performance and profits are significantly impacted by the challenge of getting the right products to the right places at the right time. Therefore, a continuing need exists for solutions that help retailers increase operational efficiencies, create intimate customer experiences, streamline processes, and provide real-time understanding of customer behavior in the store. Provided herein are automated inventory intelligence systems and methods that address the foregoing.

### SUMMARY

Provided herein is an automated inventory intelligence system including, in some embodiments, an artificial intelligence (“AI”) agent configured to monitor inventory states in one or more designated areas of an environment. The AI agent includes one or more sensors, one or more effectors, and an agent program. The one or more sensors are configured to be disposed in the environment to collect sensory information on inventory items in the one or more designated areas. The one or more effectors are configured for response to inventory state changes in the one or more designated areas. The agent program is configured to receive sensor data from the one or more sensors for current inventory states, as well as send instructions to the one or more effectors for the response to the inventory state changes. In addition, the automated inventory intelligence system may include a system memory configured to store an instance of the agent program at runtime and one or more previous inventory states for determining the inventory state changes from the current inventory states.

In some embodiments, the inventory state changes include changes in quantities of the inventory items, rearrangements of the inventory items, prolonged obstructions to collecting the sensory information on the inventory items, or a combination thereof. The AI agent is configured to determine the inventory state changes in accordance with monitoring the inventory states.

In some embodiments, the agent program includes an inventory assessment module and an inventory estimation module. The inventory assessment module is configured to receive the one or more previous inventory states from the system memory. The inventory estimation module is configured to estimate quantities of the inventory items from the sensor data for the current inventory states. With the one or more previous inventory states and the current inventory states and, the inventory assessment module is configured to determine the inventory state changes.

In some embodiments, the agent program includes an action assessment module configured to receive the inventory state changes. The system memory is configured to store one or both inventory evolution models selected from an AI agent-independent inventory evolution model and an AI agent-dependent inventory evolution model. The action assessment module is configured to receive the one or both inventory evolution models to determine from the inventory state changes whether or not an action is required in response to the inventory state changes.

In some embodiments, the AI agent includes an agent function having inventory-action rules configured for determining from the inventory state changes what action is required in response to the inventory state changes. The agent program is configured to implement the agent function.

In some embodiments, the automated inventory intelligence system further includes a data controller configured to manage a sensor data flow from the one or more sensors to the agent program.

In some embodiments, the one or more sensors are one or more digital cameras configured to be disposed in the environment in the one or more designated areas. Each camera is configured to be disposed in a designated area are selected from i) under an upper shelf of a shelving unit in an orientation to view the inventory items on an inventory item-containing shelf beneath the upper shelf, ii) on an opposing shelving unit or other structure across an aisle from the shelving unit containing the inventory item-containing shelf in an orientation to view the inventory items on the inventory item-containing shelf, and iii) on the inventory item-containing shelf of the shelving unit in an orientation to view the inventory items on the inventory item-containing shelf. Optionally, the one or more digital cameras are mounted on pegboard of the shelving unit containing the inventory item-containing shelf.

In some embodiments, the one or more effectors are communications configured as e-mail messages, short message service (“SMS”) messages, multimedia service (“MMS”) messages, automated telephone calls, voice mail messages, web browser pop-ups, or a combination thereof. Such communications are initiated at a communication interface of the automated inventory intelligence system.

In some embodiments, the environment in which the automated inventory intelligence system is disposed is a retailer or a warehouse in which case inventory may be contained on pallets, bins, racks, or other storage systems.

Provided herein is an automated inventory intelligence system including, in some embodiments, an AI agent, a system memory, and a data controller. The AI agent is configured to monitor inventory states in one or more designated areas of an environment selected from a retailer or a warehouse. The AI agent includes a number of digital cameras, a number of effectors, an agent program, and an agent function. The digital cameras are configured to be disposed in the environment to collect sensory information on inventory items in the one or more designated areas. The effectors are configured for response to inventory state changes in the one or more designated areas, each effector being a communication selected from an e-mail message, a short message service (“SMS”) message, a multimedia service (“MMS”) message, an automated telephone call, a voice mail message, and a web browser pop-up initiated at a communication interface of the automated inventory intelligence system. The agent program is configured to receive sensor data from the number of digital cameras and send instructions to the number of effectors for the response to the inventory state changes. The agent program includes an inventory estimation module, an inventory assessment module, and an action assessment module. The inventory estimation module is configured to estimate quantities of the inventory items from the sensor data for current inventory states. The inventory assessment module is configured to receive one or more previous inventory states and determine the inventory state changes from the current inventory states and the one or more previous inventory states. The action assessment module is configured to determine from the inventory state changes and one or both inventory evolution models of an AI agent-independent inventory evolution model or an AI agent-dependent inventory evolution model whether or not an action is required in response to the inventory state changes. The agent function includes inventory-action rules configured for determining from the inventory state changes what action is required in response to the inventory state changes. The system memory is configured to store instances of the agent program and the agent function at runtime. The system memory is configured to store the one or more previous inventory states to fulfill requests by the inventory assessment module for the one or more previous inventory states. The system memory is configured to store the one or both inventory evolution models to fulfill requests by the inventory assessment module for the one or both inventory evolution models. The data controller is configured to manage a sensor data flow from the digital cameras to the agent program.

In some embodiments, each digital camera of the number of digital cameras is configured to be disposed in the environment in a designated area selected from i) under an upper shelf of a shelving unit in an orientation to view the inventory items on an inventory item-containing shelf beneath the upper shelf, ii) on an opposing shelving unit or other structure across an aisle from the shelving unit containing the inventory item-containing shelf in an orientation to view the inventory items on the inventory item-containing shelf, and iii) on the inventory item-containing shelf of the shelving unit in an orientation to view the inventory items on the inventory item-containing shelf, optionally mounted on pegboard of the shelving unit containing the inventory item-containing shelf.

Also provided herein is a process of an automated inventory intelligence system including, in some embodiments, monitoring inventory states in one or more designated areas of an environment selected from a retailer and a warehouse with an AI agent, the AI agent including one or more sensors disposed in the environment, an agent program, and one or more effectors; storing one or more previous inventory states in a system memory for determining inventory state changes from current inventory states; collecting sensory information on inventory items in the one or more designated areas with the one or more sensors; determining inventory state changes with the agent program from the one or more previous inventory states received from the system memory and the current inventory states in accordance with the sensor data from the one or more sensors; sending instructions from the agent program to the one or more effectors for response to inventory state changes; and responding to the inventory state changes in the one or more designated areas with the one or more effectors.

In some embodiments, monitoring the inventory states includes monitoring changes in quantities of the inventory items, rearrangements of the inventory items, prolonged obstructions to collecting the sensory information on the inventory items, or a combination thereof.

In some embodiments, the process further includes estimating quantities of the inventory items from the sensor data for the current inventory states with an inventory estimation module of the agent program; receiving by an inventory assessment module of the agent program the one or more previous inventory states from the system memory; and determining the inventory state changes from the current inventory states and the one or more previous inventory states with the inventory assessment module.

In some embodiments, the process further includes receiving the inventory state changes by an action assessment module of the agent program; receiving one or more inventory evolution models by the action assessment module, the inventory evolution models selected from at least an AI agent-independent inventory evolution model and an AI agent-dependent inventory evolution model stored in the system memory; and determining by the action assessment module whether or not an action is required in response to the inventory state changes in view of the one or more inventory evolution models.

In some embodiments, the process further includes implementing an agent function of the AI agent; and determining with the agent function by inventory-action rules thereof what action is required in response to the inventory state changes.

In some embodiments, the process further includes managing a sensor data flow from the one or more sensors to the agent program with a data controller of the automated inventory intelligence system.

In some embodiments, the process further includes sending one or more communications configured as e-mail messages, short message service (“SMS”) messages, multimedia service (“MMS”) messages, automated telephone calls, voice mail messages, web browser pop-ups, or a combination thereof initiated at a communication interface of the automated inventory intelligence system, the one or more communications being the one or more effectors.

In some embodiments, the process further includes instantiating at least the AI agent or a portion thereof of the automated inventory intelligence system upon execution of a collection of instructions from a non-transitory computer-readable medium (“CRM”) by one or more processors of the automated inventory intelligence system.

### DRAWINGS

FIG. 1 provides a schematic illustrating an automated inventory intelligence system in accordance with some embodiments.

FIG. 2 provides a schematic illustrating an automated inventory intelligence system in accordance with some embodiments.

FIG. 3 provides a schematic illustrating an AI agent in accordance with some embodiments.

FIG. 4A provides a schematic illustrating a sensor coupled to a retail display in accordance with some embodiments.

FIG. 4B provides a schematic illustrating a sensor coupled to a retail display in accordance with some embodiments.

FIG. 4C provides a schematic illustrating a sensor coupled to a retail display in accordance with some embodiments.

FIG. 5 provides an image of a sensor positioned near merchandise stocked on a retail shelving unit in accordance with some embodiments.

FIG. 6 provides a data processing system configured to interface with the automated inventory system in accordance with some embodiments.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DESCRIPTION

Before some particular embodiments are provided in greater detail, it should be understood that the particular embodiments provided herein do not limit the scope of the concepts provided herein. It should also be understood that a particular embodiment provided herein can have features that can be readily separated from the particular embodiment and optionally combined with or substituted for features of any of a number of other embodiments provided herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

Unless defined otherwise, all technical and scientific terms used herein have the same meaning as commonly understood by those of ordinary skill in the art.

Retail environments are ever challenging. Consumers typically are confronted with pricing and information about a continuously increasing number of competitors and brands, including information about pricing, labeling, promotions, and the like. Traditionally, this information has been provided using print systems, such as slide-in paper systems, plastic label systems, and adhesive label systems. However, consumers are increasingly confounded by the sheer volume of printed information displayed in retail environments, and thus a growing number of consumers are turning to online shopping for day-to-day purchases. Furthermore, a retailer's overall performance and profits are significantly impacted by the challenge of getting the right products to the right places at the right time. Therefore, a continuing need exists for solutions that help retailers increase operational efficiencies, create intimate customer experiences, streamline processes, and provide real-time understanding of customer behavior in the store. Provided herein are automated inventory intelligence systems and methods that address the foregoing. These automated inventory intelligence systems can also be incorporated into frictionless shopping systems.

For example, an automated inventory intelligence system is provided including, in some embodiments, an AI agent configured to monitor inventory states in one or more designated areas of an environment. The AI agent includes one or more sensors, one or more effectors, and an agent program. The one or more sensors are configured to be disposed in the environment to collect sensory information on inventory items in the one or more designated areas. The one or more effectors are configured for response to inventory state changes in the one or more designated areas. The agent program is configured to receive sensor data from the one or more sensors for current inventory states, as well as send instructions to the one or more effectors for the response to the inventory state changes. In addition, the automated inventory intelligence system includes a system memory configured to store an instance of the agent program at runtime and one or more previous inventory states for determining the inventory state changes from the current inventory states.

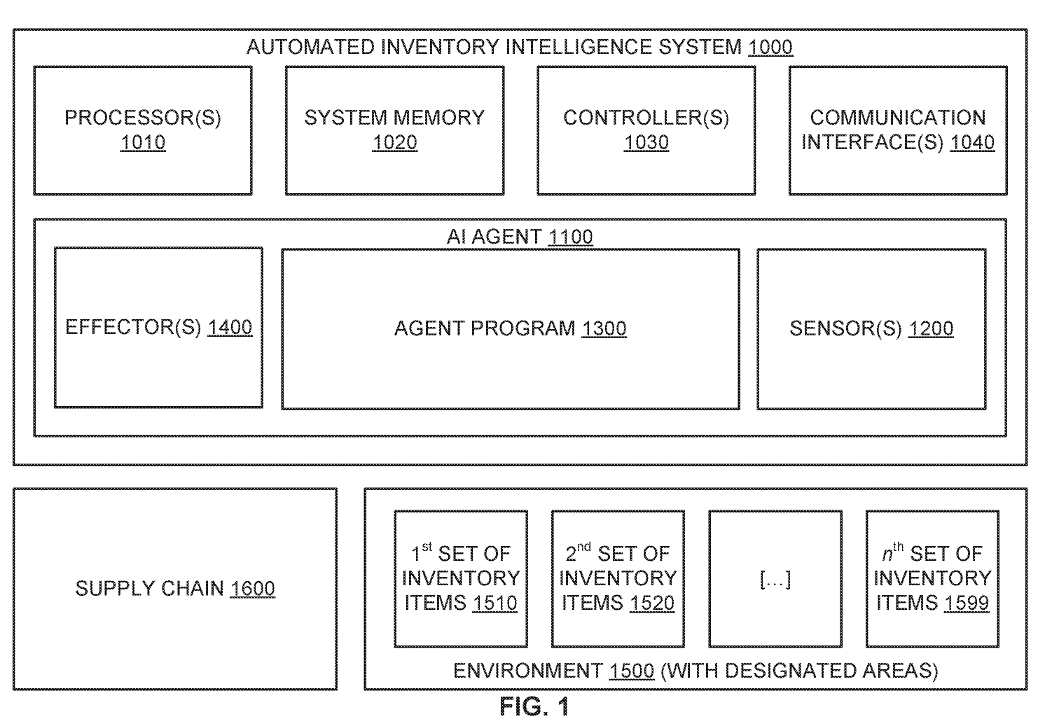

FIG. 1 provides a schematic illustrating an automated inventory intelligence system 1000 in accordance with some embodiments. FIG. 1 further provides an environment 1500, in which, the automated inventory intelligence system 1000 at least partially operates, and a supply chain 1600, of which, the automated inventory intelligence system 1000 is part.

As shown, the automated inventory intelligence system 1000 includes one or more processors 1010, a system memory 1020, one or more controllers 1030, one or more communication interfaces 1040, and an AI agent 1100. The AI agent 110 includes at least one or more sensors 1200, an agent program 1300, and one or more effectors 1400. The system memory 1020 is configured to store one or more instances respectively of one or more components of the AI agent 1100 such as the agent program 1300, as well as any other collections of instructions and data needed by the AI agent 1100.

The automated inventory intelligence system 1000 is shown in FIG. 1 as separate from the environment 1500; however, the automated inventory intelligence system 1000 is configured to be at least partially disposed in the environment 1500 in that the sensors 1200 are configured to be disposed in the environment 1500 to collect sensory information in one or more designated areas of the environment 1500. Such designated areas are shown in FIG. 1 as including a first set of inventory items 1510, a second set of inventory items 1520, and up to an n^{th} set of inventory items 1599. The environment 1500 includes, but is not limited to, a retailer or a warehouse.

The automated inventory intelligence system 1000 is shown in FIG. 1 as separate from the supply chain 1600; however, the automated inventory intelligence system 1000 is a part of the supply chain 1600 or at least the management thereof in that the AI agent 1100 is configured to monitor inventory states in the designated areas of the environment 1500 through the sensors 1200 and communicate the inventory states to one or more members of the supply chain 1600 through the effectors 1400. In this way, the automated inventory intelligence system 1000 is an important aspect of supply chain management.

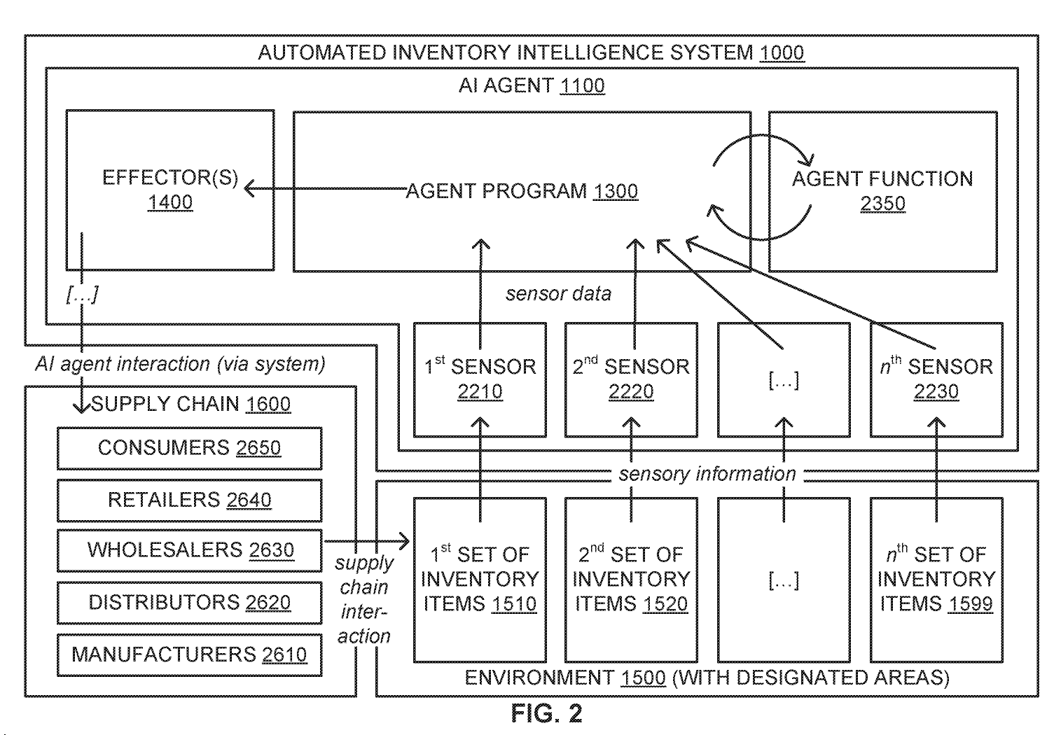

FIG. 2 provides a schematic illustrating the automated inventory intelligence system 1000 in accordance with some embodiments. FIG. 2 further provides interactions of the automated inventory intelligence system 1000 with the environment 1500 and the supply chain 1600.

As shown, AI agent 1100 of the automated inventory intelligence system 1000 further includes an agent function 2350, as well as a first sensor 2210, a second sensor 2220, and up to a n^{th} sensor 2230 of the sensors 1200. The supply chain 1600, of which, the automated inventory intelligence system 1000 is a part, includes manufacturers 2610, distributors 2620, wholesalers 2630, retailers 2640, and consumers 2650.

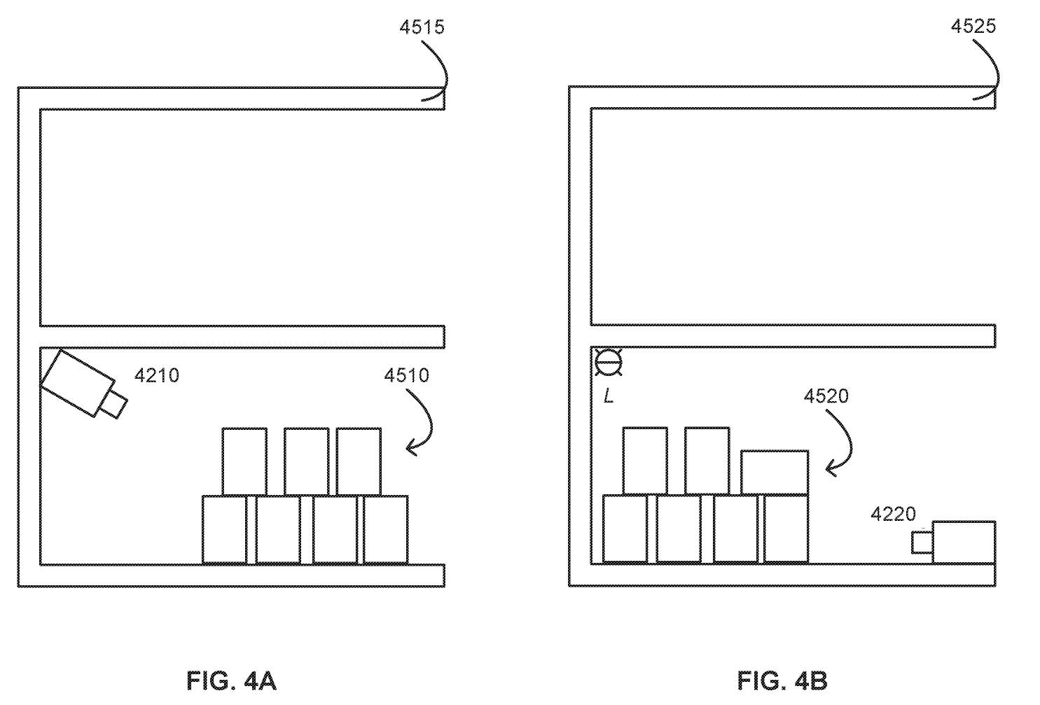

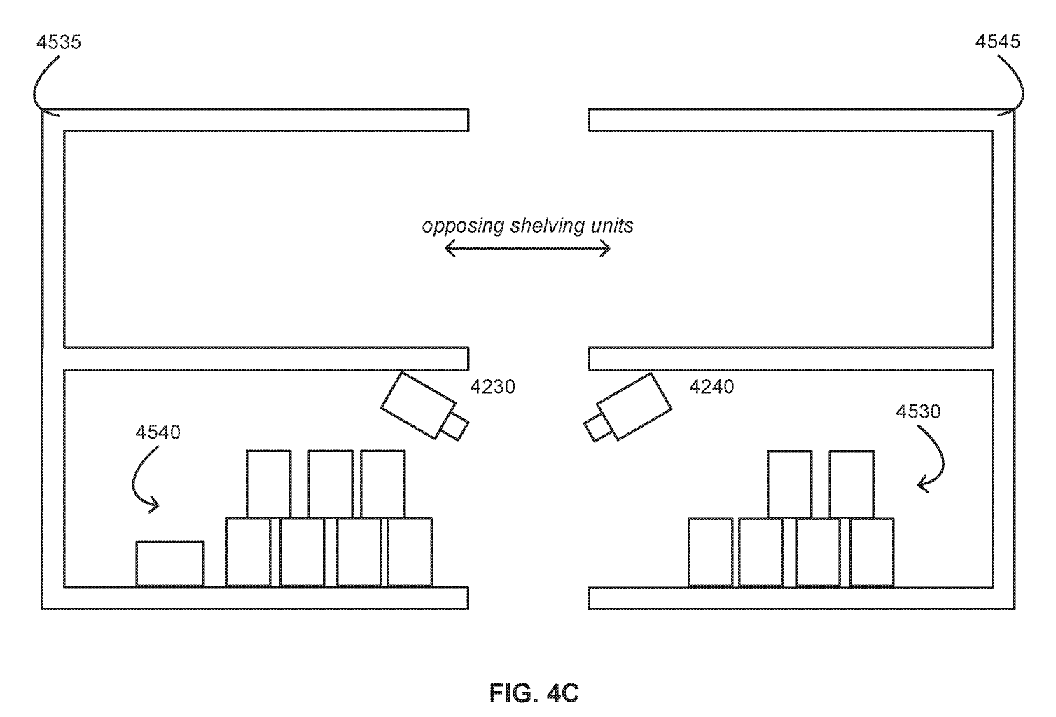

The AI agent 1100 is configured to monitor inventory states in the designated areas of the environment 1500, which designated areas are shown in FIG. 2 as including the first set of inventory items 1510, the second set of inventory items 1520, and up to the n^{th} set of inventory items 1599. Again, the environment 1500 includes, but is not limited to, a retailer or a warehouse, and, as such, the first set of inventory items 1510, the second set of inventory items, or any other set of inventory items up to the n^{th} set of inventory items 1599 can be displayed or stored in one or more retail displays or warehouse storage units. As described in more detail in reference to FIGS. 4A-4C, the sensors 1200 of the AI agent 1100 are configured to be disposed in the environment 1500 such as by coupling the sensors 1200 to the retail displays or warehouse storage units with one sensor for every set of inventory items (e.g., one-to-one relationship), one sensor for a number of sets of inventory items (e.g., one-to-many relationship), or a combination thereof. For example, FIG. 2 shows a one-to-one relationship of the first sensor 2210 to the first set of inventory items 1510, the second sensor 2220 to the second set of inventory items 1520, and so on, but monitoring inventory states by of the AI agent 1100 is not limited thereto. Once in place in the environment 1500, each sensor of the sensors 1200 can be suitably physically oriented, programmatically focused, or both on one or more sets of the inventory items for collecting sensory information on the inventory items in the designated areas for current inventory states.

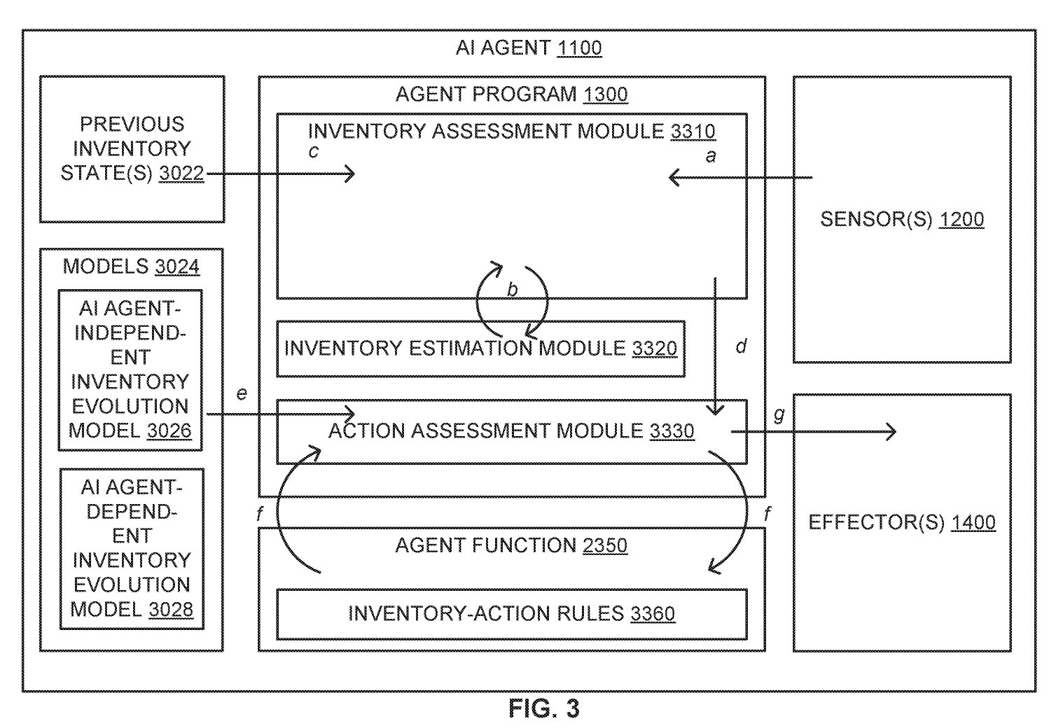

The agent program 1300 of the AI agent 1100 is configured to receive the sensory information from the sensors 1200 as digitized sensor data for monitoring inventory states in the designated areas of the environment 1500. Sensor data flow from the sensors 1200 to the agent program 1300 can be controlled by the one or more data controllers 1030 of the automated inventory intelligence system 1000. The inventory state changes monitored by the agent program 1300 include changes in one or more sets of the inventory items such as changes in quantities of the inventory items, rearrangements of the inventory items, prolonged obstructions to collecting the sensory information on the inventory items, or a combination thereof. The agent program 1300 is configured to implement the agent function 2350, which includes inventory-action rules 3360 (see FIG. 3) configured for determining from the inventory state changes what actions are required in response to the inventory state changes.

The effectors 1400 are configured to act in response to the inventory state changes and elicit an effect in supply chain management by interacting with the supply chain 1600 or a member thereof such as the manufacturers 2610, distributors 2620, wholesalers 2630, retailers 2640, or the consumers 2650. In a number of embodiments, the effectors 1400 can be, but are not limited to, communications configured as e-mail messages, short message service (“SMS”) messages, multimedia service (“MMS”) messages, automated telephone calls, voice mail messages, web browser pop-ups, or a combination thereof, the communications intended to prompt a relevant supply chain interaction with respect to the sets of inventory items with inventory state changes. In additional embodiments, the effectors 1400 may also comprise data feeds, web services, application programming interfaces, or through direct database integration with customers and/or retailer's data systems. Such communications are initiated at the one or more communication interfaces 140 of the automated inventory intelligence system 1000.

FIG. 3 provides a schematic illustrating the AI agent 1100 in accordance with some embodiments. FIG. 3 further provides process flowchart elements to aid description of the AI agent configuration for monitoring the inventory states in the designated areas of the environment 1500; however, arrows a-g, which are used as the process flowchart elements, are for expository expediency and, as such, need not impose any particular order.

Again, the AI agent 110 includes the one or more sensors 1200, the agent program 1300, the one or more effectors 1400, and the agent function 2350. The agent program 1300 includes an inventory assessment module 3310, an inventory estimation module 3320, and an action assessment module 3330, while the agent function 2350 includes the inventory-action rules 3360. The system memory 1020 of the automated inventory intelligence system 1000 is configured to store instances of the agent program 1300 and the agent function 2350 at runtime. In addition, the system memory 1020 is configured to store one or more previous inventory states 3022 for determining the inventory state changes from the current inventory states, as well as one or more inventory evolution models 3024 for determining from the inventory state changes whether or not an action is required in response to the inventory state changes. The inventory evolution models are selected from at least an AI agent-independent inventory evolution model 3026 and an AI agent-dependent inventory evolution model 3028.

The inventory assessment module 3310 of the agent program 1300 is configured to receive sensor data from the sensors 1200 for current inventory states in accordance with the arrow a. If the inventory assessment module 3310 determines a probable change in quantity for any set of inventory items in the environment 1500, the inventory assessment module 3310 is configured to work with the inventory estimation module 3320 in accordance with the arrow b to estimate a current inventory state for the set of inventory items with the probable change. Estimation is beneficial in that sets of inventory items can vary throughout a day as the inventory items are rearranged by way of adding, removing, or replacing the inventory items. For example, a stack of bread might be tightly packed in a retail display by a distributor at a beginning of a day, but toward an end of the day, the stack of bread might be loosely packed and occupying about the same space in the retail display. In many embodiments, the estimation module can be configured to provide up to a 95% accuracy or more in estimating a current inventory state for a set of inventory items. The inventory assessment module 3310 is also configured to receive one or more previous inventory states 3022 from the system memory 1020 in accordance with the arrow c. The inventory assessment module 3310 is configured to ultimately determine an inventory state change from the one or more previous inventory states 3022 and a current inventory state, whether or not the inventory estimation module 3320 is utilized.

The action assessment module 3330 of the agent program 1300 is configured to receive the inventory state changes from the inventory assessment module 3310 in accordance with the arrow d. The action assessment module 3330 is also configured to receive the one or more inventory evolution models 3024 (e.g., the AI agent-independent inventory evolution model 3026 and the AI agent-dependent inventory evolution model 3028) in accordance with the arrow e for determining from the inventory state changes whether or not an action is required in response to the inventory state changes. The AI agent-dependent inventory evolution model 3028 is beneficial in determining whether or not inventory state changes result from the AI agent 1100, for example, by way of the effectors 1400, which can prompt one or more members of the supply chain 1600 to change inventory states. The AI agent-independent inventory evolution model 3026 is beneficial in determining whether or not inventory state changes result from agents other than the AI agent 1100 such as by one or more members of the supply chain 1600 changing inventory states without a prompt by the AI agent 1100. In the AI-agent independent inventory evolution model 3026, an inventory state change might result from, for example, rotating stock due to a seasonal change.

Where the action assessment module 3330 is configured to determine whether or not an action is required in response to an inventory state change, the agent function 2350 is implemented by the agent program 1300 in accordance with the arrow f to determine what action is required in response to an inventory state change. The agent function 2350 includes the inventory-action rules 3360 configured for determining from the inventory state changes what action is required in response to the inventory state changes. When it is determined that an action is required in response to an inventory state change, instructions for the response are sent to the effectors 1400 in accordance with the arrow g in order to elicit an effect in supply chain management. It is also contemplated that certain retailers may simply want to utilize any collected data outside of supply chain management environments for other applications. If it is determined that no action is required in response to an inventory change, no such instructions are sent to the effectors 1400.

FIGS. 4A-4C provide schematics illustrating sensors coupled to retail displays in accordance with some embodiments.

The sensors 1200 of the AI agent 1100 are configured to be disposed in the environment 1500 such as by coupling the sensors 1200 to retail displays or warehouse storage units. Such retail displays include, but are not limited to, shelves, panels (e.g., pegboard, gridwall, slatwall, etc.), tables, cabinets, cases, bins, boxes, stands, and racks, and such warehouse storage includes, but is not limited to, shelves, cabinets, bins, boxes, and racks. The sensors 1200 can be coupled to the retail displays or the warehouse storage units with one sensor for every set of inventory items (e.g., one-to-one relationship), one sensor for a number of sets of inventory items (e.g., one-to-many relationship), or a combination thereof. The sensors 1200 can also be coupled to the retail displays or the warehouse storage units with more than one sensor for every set of inventory items (e.g., many-to-one relationship), more than one sensor for a number of sets of inventory items (e.g., many-to-many relationship), or a combination thereof. In an example of a many-to-one relationship, at least two same sensors for a set of inventory items provides contemporaneous sensor data for the set of inventory items, which is useful for sensor data redundancy/augmentation or simply having a backup. In another example of a many-to-one relationship, at least two different sensors for a set of inventory items provides complementary sensor data for the set of inventory items, which is useful for differentially determining from inventory state changes whether or not an action is required in response to the inventory state changes. Each figure of FIGS. 4A-4C shows a one-to-one relationship of a sensor to a set of inventory items, but each sensor can alternatively be in one of the foregoing alternative relationships with one or more sets of inventory items. Each sensor can typically be programmatically focused on the one or more sets of inventory items for monitoring the inventory states by of the AI agent 1100.

The sensors 1200 include, but are not limited to, light- or sound-based sensors such as digital cameras and microphones, respectively. In some embodiments, the sensors 1200 are digital cameras with a wide viewing angle up to a 180°-wide viewing angle or more.

FIG. 4A provides a schematic illustrating a sensor such as a digital camera 4210 coupled to a retail shelving unit 4515 in accordance with some embodiments. As shown, the digital camera 4210 can be coupled to or mounted on the retail shelving unit 4515 under an upper shelf of the retail shelving unit 4515 in an orientation to view a set of inventory items 4510 on an inventory item-containing shelf beneath the upper shelf. While the digital camera 4210 is shown mounted inside the retail shelving unit 4515 such as on a back (e.g., pegboard) of the retail shelving unit 4515 and looking out from the retail shelving unit 4515, the digital camera 4210 can alternatively be coupled to the upper shelf and looking in to the retail shelving unit 4515. Due to a wide viewing angle which can be any angle of up to 180° or more, whether looking out from or in to the retail shelving unit 4515, the digital camera 4210 can collect visual information on sets of inventory items adjacent to the set of inventory items 4510.

FIG. 4B provides a schematic illustrating a sensor such as a digital camera 4220 coupled to a retail shelving unit 4525 in accordance with some embodiments. As shown, the digital camera 4220 can be coupled to or mounted on the retail shelving unit 4525 on an inventory-item containing shelf of the retail shelving unit 4525 in an orientation to view a set of inventory items 4520 on the inventory item-containing shelf. While the digital camera 4210 is shown mounted inside the retail shelving unit 4525 on the inventory item-containing shelf and looking in to the retail shelving unit 4525, which can be advantageous when a light L is present in a back of the retail shelving 4525, the digital camera 4220 can alternatively be coupled to the inventory item-containing shelf and looking out from the retail shelving unit 4525. Due to a wide viewing angle of up to 180°, whether looking in to or out from the retail shelving unit 4525, the digital camera 4220 can collect visual information on sets of inventory items adjacent to the set of inventory items 4520. It is also contemplated that the exact mounting position of the digital camera 4220 may be changed to facilitate a better viewing angle based on the needs of the application. By way of example and not limitation, the digital camera 4220 may be positioned directly underneath the upper shelf with an angle pointed downward towards the inventory items 4520.

FIG. 4C provides a schematic illustrating a sensor such as a digital camera 4230 coupled to a retail shelving unit 4535 in accordance with some embodiments. In addition, FIG. 4C further provides another sensor such as a digital camera 4240 coupled to a retail shelving unit 4545 in accordance with some embodiments. As shown, the digital camera 4230 can be coupled to or mounted on the retail shelving unit 4535 in an orientation to view a set of inventory items 4530 on an inventory-item containing shelf of an opposing shelving unit across an aisle such as the retail shelving unit 4545. Likewise, the digital camera 4240 can be coupled to or mounted on the retail shelving unit 4545 in an orientation to view a set of inventory items 4540 on an inventory-item containing shelf of an opposing shelving unit across an aisle such as the retail shelving unit 4535. Due to wide viewing angles of up to 180°, the digital camera 4230 can collect visual information on sets of inventory items on the retail shelving unit 4545 adjacent to the set of inventory items 4530, and the digital camera 4240 can collect visual information on sets of inventory items on the retail shelving unit 4535 adjacent to the set of inventory items 4540.

In some embodiments, digital cameras such as digital cameras 4210, 4220, 4230, and 4240 are coupled to or mounted on ends of the retail shelving units to collect visual information while looking in to the retail shelving units.

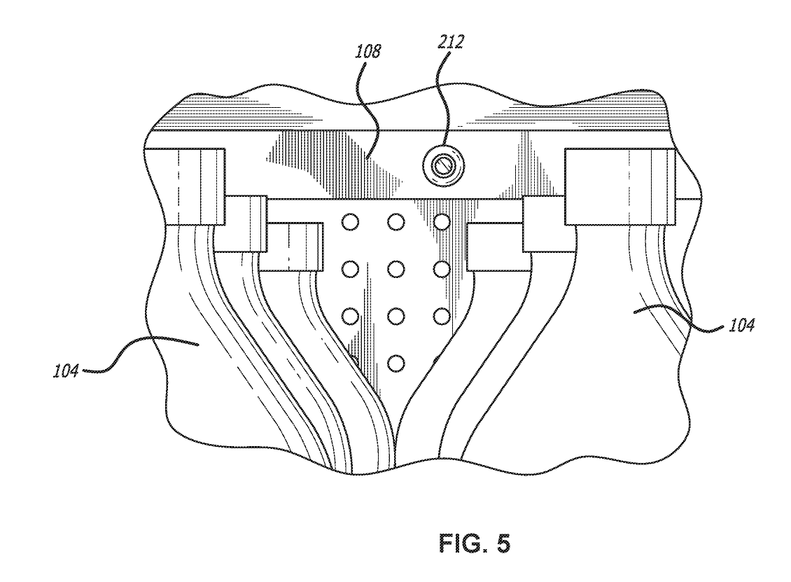

FIG. 5 provides an image of a sensor 212 positioned near merchandise 104 stocked on a retail shelving unit 108 in accordance with some embodiments. The sensor 212 of FIG. 5 includes a digital camera; however, in other embodiments, each sensor of the sensors 1200 includes can be any sensing device whereby merchandise stocked on a shelving unit can be monitored. The sensors 1200 are configured to be coupled to the retail displays and warehouse shelving units by way of any fastening means deemed suitable, such as, by way of non-limiting example, magnets, adhesives, brackets, hardware fasteners, and the like. Further, the location of a sensor such as sensor 212 is not to be limited to the location shown in FIG. 5. It should be understood that a sensor can be disposed in any location with respect to a retail display or warehouse storage unit whereby the stocker merchandise can be monitored. (See, for example, FIGS. 4A-4C.) Furthermore, the locations best suited to receive sensors 1200 will generally depend upon one or more factors, such as, for example, the type of merchandise, an ability to capture a desired quantity of merchandise within the field of view of the sensors 1200, as well as the methods whereby customers typically remove merchandise from the retail display units.

Any of the retail displays or warehouse storage units outfitted with the automated inventory intelligence system 1000 can monitor the quantity of stocked merchandise by way of the sensors 1200 and then create a notification or an alert once the remaining merchandise is reduced to a predetermined minimum threshold quantity. For example, low-inventory alerts can be created when the remaining merchandise is reduced to 50% and 20% thresholds. The low-inventory alerts can be sent to in-store staff to signal that a retail display needs to be restocked with merchandise. In some embodiments, the low-inventory alerts can include real-time images of the retail displays so that staff can see the quantity of merchandise remaining on the retail displays by way of a computer or a mobile device. In some embodiments, the low-inventory alerts can be sent in the form of text messages in real time to mobile devices carried by in-store staff. As will be appreciated, the low-inventory alerts can signal in-store staff to restock the retail displays with additional merchandise to maintain a frictionless shopping experience for consumers. In addition, with the automated inventory intelligence system 1000 can facilitate deeper analyses of sales performance by coupling actual sales with display shelf activity.

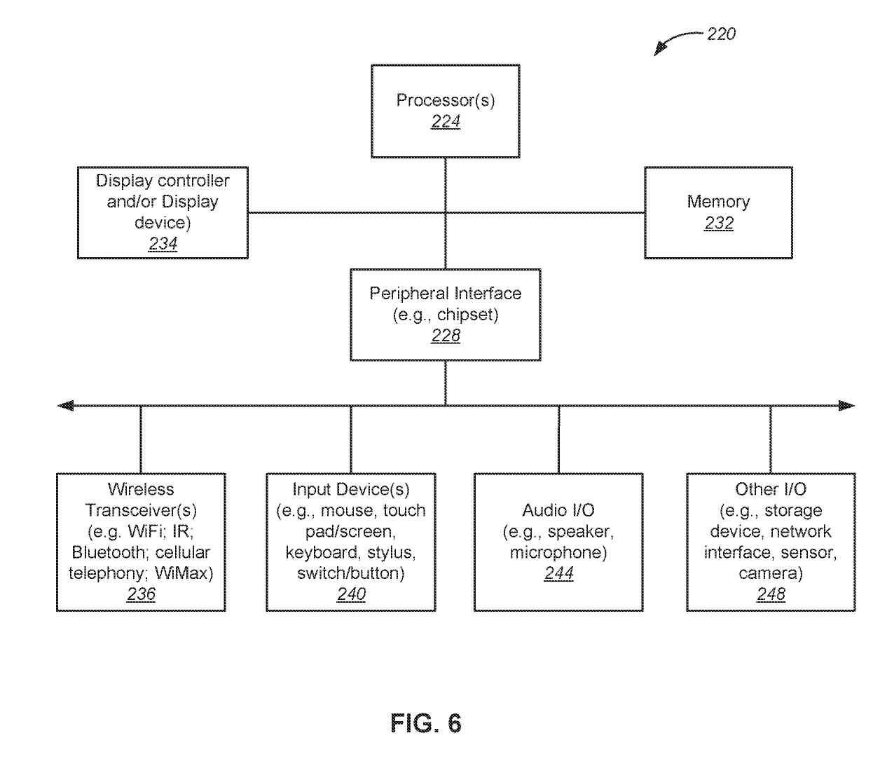

FIG. 6 provides a data processing system 220 configured to interface with the automated inventory system 1000 in accordance with some embodiments. System 220 can represent a personal computing device including, but not limited to, a desktop, a tablet, a server, a mobile phone, a media player, a personal digital assistant (“PDA”), a personal communicator, a gaming device, a network router or hub, a wireless access point or repeater, a set-top box, or a combination thereof.

The system 220 includes a processor 224 and a peripheral interface 228, also referred to herein as a chipset, to couple various components to the processor 224, including a memory 232 and devices 236-248 via a bus or an interconnect. Processor 224 can represent a single processor or multiple processors with a single processor core or multiple processor cores included therein. Processor 224 can represent one or more general-purpose processors such as a microprocessor, a central processing unit (“CPU”), or the like. More particularly, processor 224 can be a complex instruction set computing (“CISC”) microprocessor, reduced instruction set computing (“RISC”) microprocessor, very long instruction word (“VLIW”) microprocessor, or processor implementing other instruction sets, or processors implementing a combination of instruction sets. Processor 224 can also be one or more special-purpose processors such as an application specific integrated circuit (“ASIC”), a field programmable gate array (“FPGA”), a digital signal processor (“DSP”), a network processor, a graphics processor, a network processor, a communications processor, a cryptographic processor, a co-processor, an embedded processor, or any other type of logic capable of processing instructions. Processor 224 is configured to execute instructions for performing the operations and steps discussed herein.

Peripheral interface 228 can include a memory control hub (“MCH”) and an input output control hub (“ICH”). Peripheral interface 228 can include a memory controller (not shown) that communicates with a memory 232. The peripheral interface 228 can also include a graphics interface that communicates with graphics subsystem 234, which can include a display controller and/or a display device. The peripheral interface 228 can communicate with the graphics device 234 by way of an accelerated graphics port (“AGP”), a peripheral component interconnect (“PCI”) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH can be integrated with the processor 224. In such a configuration, the peripheral interface 228 operates as an interface chip performing some functions of the MCH and ICH. Furthermore, a graphics accelerator can be integrated within the MCH or the processor 224.

Memory 232 can include one or more storage (or memory) devices, such as random access memory (“RAM”), dynamic RAM (“DRAM”), synchronous DRAM (“SDRAM”), static RAM (“SRAM”), or other types of storage devices. Memory 232 can store information including sequences of instructions that are executed by the processor 224, or any other device. For example, executable code and/or data of a variety of operating systems, device drivers, firmware (e.g., input output basic system or BIOS), and/or applications can be loaded in memory 232 and executed by the processor 224. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 228 can provide an interface to IO devices, such as the devices 236-248, including wireless transceiver(s) 236, input device(s) 240, audio IO device(s) 244, and other IO devices 248. Wireless transceiver 236 can be a WiFi transceiver, an infrared transceiver, a Bluetooth transceiver, a WiMax transceiver, a wireless cellular telephony transceiver, a satellite transceiver (e.g., a global positioning system (“GPS”) transceiver) or a combination thereof. Input device(s) 240 can include a mouse, a touch pad, a touch sensitive screen (which can be integrated with display device 234), a pointer device such as a stylus, and/or a keyboard (e.g., physical keyboard or a virtual keyboard displayed as part of a touch sensitive screen). For example, the input device 240 can include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 244 can include a speaker and/or a microphone to facilitate voice-enabled functions, such as voice recognition, voice replication, digital recording, and/or telephony functions. Other optional devices 248 can include a storage device (e.g., a hard drive, a flash memory device), universal serial bus (“USB”) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 248 can further include an imaging processing subsystem (e.g., a camera), which can include an optical sensor, such as a charged coupled device (“CCD”) or a complementary metal-oxide semiconductor (“CMOS”) optical sensor, utilized to facilitate camera functions, such as recording photographs and video clips.

Note that while FIG. 6 illustrates various components of a data processing system, it is not intended to represent any particular architecture or manner of interconnecting the components. Indeed, aspects of the data processing system 220 can also be used in the automated inventory intelligence system 1000. It should also be appreciated that network computers, handheld computers, mobile phones, and other data processing systems, which have fewer components or perhaps more components, can also be used with embodiments of the invention disclosed hereinabove.

Some portions of the description provided herein have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other similar information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures can be performed by processing logic that includes hardware (e.g. circuitry, dedicated logic, etc.), firmware, software (e.g., embodied on a non-transitory computer readable medium), or a combination of these. Although the processes or methods are described above in terms of some sequential operations, it should be appreciated that some of the operations described can be performed in a different order. Moreover, some operations can be performed in parallel rather than sequentially.

While some particular embodiments have been provided herein, and while the particular embodiments have been provided in some detail, it is not the intention for the particular embodiments to limit the scope of the concepts presented herein. Additional adaptations and/or modifications can appear to those of ordinary skill in the art, and, in broader aspects, these adaptations and/or modifications are encompassed as well. Accordingly, departures can be made from the particular embodiments provided herein without departing from the scope of the concepts provided herein.

What is claimed is:

1. An automated inventory intelligence system, comprising:
an artificial intelligence (“AI”) agent configured to monitor inventory states in one or more designated areas of an environment, the AI agent comprising:
one or more sensors configured to be disposed in the environment to collect sensory information on inventory items in the one or more designated areas;
one or more effectors configured for response to inventory state changes in the one or more designated areas; and
an agent program configured to receive sensor data from the one or more sensors for current inventory states and send instructions to the one or more effectors for the response to the inventory state changes; and
a system memory configured to store an instance of the agent program at runtime and one or more previous inventory states for determining the inventory state changes from the current inventory states.

2. The automated inventory intelligence system of claim 1,
wherein the inventory state changes include changes in quantities of the inventory items, rearrangements of the inventory items, prolonged obstructions to collecting the sensory information on the inventory items, or a combination thereof, and
wherein the AI agent is configured to determine the inventory state changes in accordance with monitoring the inventory states.

3. The automated inventory intelligence system of claim 2, the agent program comprising:
an inventory assessment module configured to receive the one or more previous inventory states from the system memory; and
an inventory estimation module configured to estimate quantities of the inventory items from the sensor data for the current inventory states,
wherein the inventory assessment module is configured to determine the inventory state changes from the current inventory states and the one or more previous inventory states.

4. The automated inventory intelligence system of claim 3, the agent program comprising:
an action assessment module configured to receive the inventory state changes,
wherein the system memory is configured to store one or both inventory evolution models selected from an AI agent-independent inventory evolution model and an AI agent-dependent inventory evolution model, and
wherein the action assessment module is configured to receive the one or more inventory evolution models to determine from the inventory state changes whether or not an action is required in response to the inventory state changes.

5. The automated inventory intelligence system of claim 4, the AI agent comprising:
an agent function including inventory-action rules configured for determining from the inventory state changes what action is required in response to the inventory state changes,
wherein the agent program is configured to implement the agent function.

6. The automated inventory intelligence system of claim 5, further comprising a data controller configured to manage a sensor data flow from the one or more sensors to the agent program.

7. The automated inventory intelligence system of claim 6, wherein the one or more sensors are one or more digital cameras configured to be disposed in the environment in the one or more designated areas, each camera configured to be disposed in a designated area selected from i) under an upper shelf of a shelving unit in an orientation to view the inventory items on an inventory item-containing shelf beneath the upper shelf, ii) on an opposing shelving unit or other structure across an aisle from the shelving unit containing the inventory item-containing shelf in an orientation to view the inventory items on the inventory item-containing shelf, and iii) on the inventory item-containing shelf of the shelving unit in an orientation to view the inventory items on the inventory item-containing shelf, optionally mounted on pegboard of the shelving unit containing the inventory item-containing shelf.

8. The automated inventory intelligence system of claim 7, wherein the one or more effectors are communications configured as e-mail messages, short message service (“SMS”) messages, multimedia service (“MMS”) messages, automated telephone calls, voice mail messages, web browser pop-ups, or a combination thereof initiated at a communication interface of the automated inventory intelligence system.

9. The automated inventory intelligence system of claim 8, wherein the environment is a retailer or a warehouse.

10. An automated inventory intelligence system, comprising:
an artificial intelligence (“AI”) agent configured to monitor inventory states in one or more designated areas of an environment selected from a retailer and a warehouse, the AI agent comprising:
a plurality of digital cameras configured to be disposed in the environment to collect sensory information on inventory items in the one or more designated areas;
a plurality of effectors configured for response to inventory state changes in the one or more designated areas, each effector of the plurality of effectors being a communication selected from an e-mail message, a short message service (“SMS”) message, a multimedia service (“MMS”) message, an automated telephone call, a voice mail message, and a web browser pop-up initiated at a communication interface of the automated inventory intelligence system;
an agent program configured to receive sensor data from the plurality of digital cameras and send instructions to the plurality of effectors for the response to the inventory state changes, the agent program comprising:
an inventory estimation module configured to estimate quantities of the inventory items from the sensor data for current inventory states;
an inventory assessment module configured to receive one or more previous inventory states and determine the inventory state changes from the current inventory states and the one or more previous inventory states; and
an action assessment module configured to determine from the inventory state changes and one or both inventory evolution models of an AI agent-independent inventory evolution model or an AI agent-dependent inventory evolution model whether or not an action is required in response to the inventory state changes; and
an agent function including inventory-action rules configured for determining from the inventory state changes what action is required in response to the inventory state changes;
a system memory configured to store instances of the agent program and the agent function at runtime, as well as the one or more previous inventory states and the one or both inventory evolution models to fulfill requests by the inventory assessment module for the one or more previous inventory states and the action assessment module for the one or both inventory evolution models; and
a data controller configured to manage a sensor data flow from the digital cameras to the agent program.

11. The automated inventory intelligence system of claim 10, wherein each digital camera of the plurality of digital cameras is configured to be disposed in the environment in a designated area selected from i) under an upper shelf of a shelving unit in an orientation to view the inventory items on an inventory item-containing shelf beneath the upper shelf, ii) on an opposing shelving unit or other structure across an aisle from the shelving unit containing the inventory item-containing shelf in an orientation to view the inventory items on the inventory item-containing shelf, and iii) on the inventory item-containing shelf of the shelving unit in an orientation to view the inventory items on the inventory item-containing shelf, optionally mounted on pegboard of the shelving unit containing the inventory item-containing shelf.

12. A process of an automated inventory intelligence system, comprising:
monitoring inventory states in one or more designated areas of an environment selected from a retailer and a warehouse with an artificial intelligence (“AI”) agent, the AI agent comprising one or more sensors disposed in the environment, an agent program, and one or more effectors;
storing one or more previous inventory states in a system memory for determining inventory state changes from current inventory states;
collecting sensory information on inventory items in the one or more designated areas with the one or more sensors;
determining inventory state changes with the agent program from the one or more previous inventory states received from the system memory and the current inventory states in accordance with the sensor data from the one or more sensors;
sending instructions from the agent program to the one or more effectors for response to inventory state changes; and
responding to the inventory state changes in the one or more designated areas with the one or more effectors.

13. The process of the automated inventory intelligence system of claim 12, wherein monitoring the inventory states includes monitoring changes in quantities of the inventory items, rearrangements of the inventory items, prolonged obstructions to collecting the sensory information on the inventory items, or a combination thereof.

14. The process of the automated inventory intelligence system of claim 13, further comprising:
estimating quantities of the inventory items from the sensor data for the current inventory states with an inventory estimation module of the agent program;
receiving by an inventory assessment module of the agent program the one or more previous inventory states from the system memory; and
determining the inventory state changes from the current inventory states and the one or more previous inventory states with the inventory assessment module.

15. The process of the automated inventory intelligence system of claim 14, further comprising:
receiving the inventory state changes by an action assessment module of the agent program;
receiving one or more inventory evolution models by the action assessment module, the inventory evolution models selected from at least an AI agent-independent inventory evolution model and an AI agent-dependent inventory evolution model stored in the system memory; and
determining by the action assessment module whether or not an action is required in response to the inventory state changes in view of the one or more inventory evolution models.

16. The process of the automated inventory intelligence system of claim 15, further comprising:
implementing an agent function of the AI agent, the agent function including inventory-action rules; and
determining with the agent function by the inventory-action rules what action is required in response to the inventory state changes.

17. The process of the automated inventory intelligence system of claim 16, further comprising managing a sensor data flow from the one or more sensors to the agent program with a data controller of the automated inventory intelligence system.

18. The process of the automated inventory intelligence system of claim 17, further comprising sending one or more communications configured as e-mail messages, short message service (“SMS”) messages, multimedia service (“MMS”) messages, automated telephone calls, voice mail messages, web browser pop-ups, or a combination thereof initiated at a communication interface of the automated inventory intelligence system, the one or more communications being the one or more effectors.

19. The process of the automated inventory intelligence system of claim 18, wherein the environment is a retailer or a warehouse.

20. The process of the automated inventory intelligence system of claim 19, further comprising instantiating at least the AI agent or a portion thereof of the automated inventory intelligence system upon execution of a collection of instructions from a non-transitory computer-readable medium (“CRM”) by one or more processors of the automated inventory intelligence system.
